(19) United States
(12) Patent Application Publication
(10) Pub. No.: US 2026/0107862 A1
(43) Pub. Date: Apr. 23, 2026

(54) TINE RAKE ASSEMBLY FOR AN AGRICULTURAL IMPLEMENT

(71) Applicant: CNH Industrial America LLC, New Holland, PA (US)

(72) Inventors: Brian James Rudin, Bloomington, IL (US); Timothy Richard Blunier, North Danvers, IL (US)

(21) Appl. No.: 19/365,749

(22) Filed: Oct. 22, 2025

Related U.S. Application Data
(60) Provisional application No. 63/710,243, filed on Oct. 22, 2024.

(51) Int. Cl. A01B 23/02

(52) U.S. Cl. CPC A01B 23/02

(57) ABSTRACT

A tine rake assembly for an agricultural implement includes a frame configured to pivotally couple to a chassis of the agricultural implement. The frame is configured to rotate between a working position and at least one storage position. In addition, the tine rake assembly includes multiple tines that are non-movably coupled to the frame. Each tine is configured to be disposed within a region extending between a respective pair of ground engaging tools while the frame is in the working position. Otherwise, each tine is configured to be disengaged from the region while the frame is in the at least one storage position.

### CROSS-REFERENCE TO RELATED APPLICATION

This application claims priority from and the benefit of U.S. Provisional Application Serial No. 63/710,243, entitled “TINE RAKE ASSEMBLY FOR AN AGRICULTURAL IMPLEMENT”, filed October 22, 2024, which is hereby incorporated by reference in its entirety.

### BACKGROUND

The present disclosure relates generally to a tine rake assembly for an agricultural implement.

Certain agricultural implements include ground engaging tools configured to interact with the soil. Generally, tillage implements are towed behind a tractor or other work vehicle. Certain tillage implements include multiple row units distributed across a width of the tillage implement. Each row unit is configured to break up and smooth the soil for a subsequent planting or seeding operation. For example, each row unit may include one or more ground engaging tools (e.g., disc blade(s), coulter(s), residue management wheel(s), etc.) configured to interact with the soil. Furthermore, certain row units are configured to deposit an agricultural product (e.g., fertilizer) on or into the soil via an agricultural product tube.

In certain tillage implements, each row unit includes a finishing assembly (e.g., rolling basket, rolling harrow, crumbler basket, etc.) configured to smooth the soil for the subsequent planting or seeding operation. Each finishing assembly may be disposed behind the other ground engaging tool(s) of the respective row unit (e.g., disc blade(s)) relative to the direction of travel of the tillage implement. The finishing assemblies may be used to break-up soil clods, level, and smooth the soil surface tilled by the other ground engaging tool(s) (e.g., disc blade(s)). In some finishing assemblies, a set of tines is non-movably coupled to a chassis of the row unit and disposed between rotating soil finishing tools (e.g., spike wheels, fluted discs, etc.). The set of tines is configured to reduce plugging within the finishing assembly. The soil finishing tools may include a pair of gauge wheels configured to control a penetration depth of the other soil finishing tools into the soil. During usage, the finishing assembly (e.g., including the tines and the soil finishing tools) may become plugged with environmental elements (e.g., soil, residue, etc.). The process of cleaning the finishing assembly may be difficult and time-consuming.

### BRIEF DESCRIPTION

In certain embodiments, a tine rake assembly for an agricultural implement includes a frame configured to pivotally couple to a chassis of the agricultural implement. The frame is configured to rotate between a working position and at least one storage position. In addition, the tine rake assembly includes multiple tines that are non-movably coupled to the frame. Each tine is configured to be disposed within a region extending between a respective pair of ground engaging tools while the frame is in the working position. Otherwise, each tine is configured to be disengaged from the region while the frame is in the at least one storage position.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a perspective view of an embodiment of an agricultural implement having multiple row units distributed across a width of the agricultural implement;

FIG. 2 is a perspective view of an embodiment of a row unit that may be employed within the agricultural implement of FIG. 1;

FIG. 3 is a perspective view of an embodiment of a tine rake assembly that may be employed within the row unit of FIG. 2, in which a frame of the tine rake assembly is in a working position;

FIG. 4 is a perspective view of the tine rake assembly of FIG. 3, in which the frame of the tine rake assembly is in a first storage position;

FIG. 5 is a perspective view of the tine rake assembly of FIG. 3, in which the frame of the tine rake assembly is in a second storage position; and

FIG. 6 is a perspective view of the tine rake assembly of FIG. 3, in which one tine is separated from the frame.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers’ specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

A tillage implement may include at least one finishing assembly (e.g., rolling basket(s), rolling harrow(s), crumbler basket(s), etc.) configured to break up soil clods (e.g., clumps of soil) and/or churn the soil, thereby producing a level and smooth soil surface with a consistent soil texture. For example, the tillage implement may have one or more finishing assemblies, such as rolling basket assembly/assemblies, coupled to a chassis of the tillage implement. Each finishing assembly may include one or more ground engaging tools rotatably coupled to the chassis and positioned behind, with respect to a direction of travel, one or more disc blade assemblies that may be coupled to the chassis. Further, the disc blade assemblies may be used to till (e.g., plough, cultivate, turn over) the soil as a work vehicle pulls the tillage implement across the field (e.g., the soil surface).

In addition, each finishing assembly may finish and/or further till the soil surface by churning, smoothing, and leveling the tilled soil. Each finishing assembly may include finishing disc(s), rolling basket(s), other suitable type(s) of ground engaging tool(s), or a combination thereof. For example, each finishing assembly may include multiple ground engaging tools rotatably coupled to the chassis. Furthermore, a tine rake assembly may be associated with each finishing assembly. In certain embodiments, the tine rake assembly includes a frame pivotally coupled to the chassis, in which the frame is configured to rotate between a working position and at least one storage position. In addition, the tine rake assembly includes multiple tines coupled to the frame. Prior to operation of the tillage implement, the frame of each tine rake assembly may be rotated to the working position, which disposes each tine within a region extending between a respective pair of ground engaging tools of the respective finishing assembly, thereby enabling the tine rake assembly to reduce plugging of environmental elements (e.g., soil, residue, etc.) within the finishing assembly. Additionally, the frame of each tine rake assembly may be rotated to a storage position, which disengages each tine from the region, thereby facilitating cleaning of the tines and the ground engaging tools.

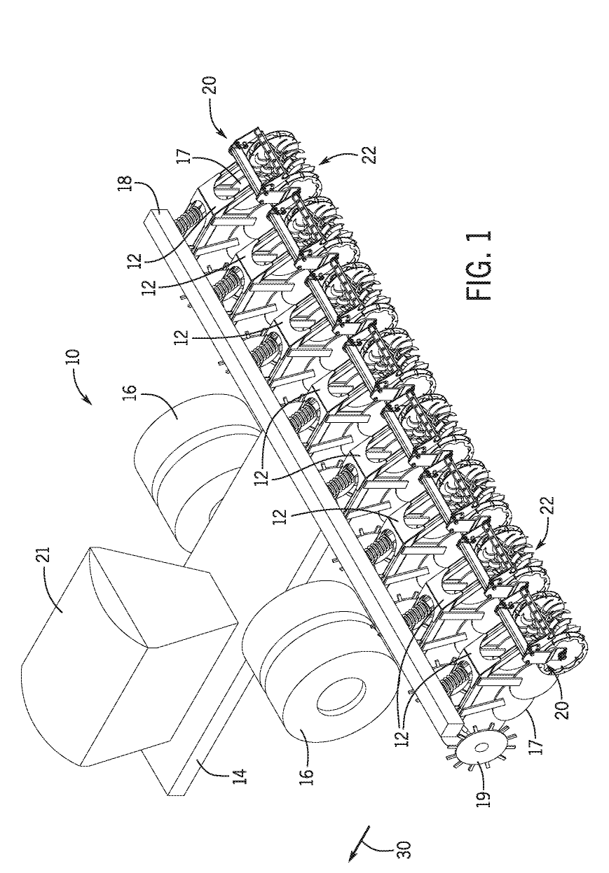

FIG. 1 is a perspective view of an embodiment of an agricultural implement 10 (e.g., tillage implement) having multiple row units 12 distributed across a width of the agricultural implement 10. The agricultural implement 10 is configured to be towed through a field behind a work vehicle, such as a tractor. As illustrated, the agricultural implement 10 includes an implement chassis 14, which includes a hitch configured to couple the agricultural implement 10 to an appropriate tractor hitch (e.g., via a ball, clevis, or other coupling). The implement chassis 14 is supported by wheels 16 and coupled to a tool bar 18 which supports multiple row units 12. Each row unit 12 includes one or more disc blades 17 configured to break up a top layer of the soil of a field. In addition, each row unit includes at least one residue management wheel 19 configured to break up and/or displace residue on the surface of the field. The row unit may also include an agricultural product conveying system (e.g., agricultural product tube) configured to deposit agricultural product (e.g., fertilizer, etc.) from a storage tank 21 onto the soil or into the soil. In addition, the row unit may include closing disc(s) configured to move displaced soil over the agricultural product. Furthermore, each row unit may include other suitable ground engaging tool(s) (e.g., alone or in combination with any of the ground engaging tools disclosed above).

In certain embodiments, at least one row unit 12 of the agricultural implement 10 (e.g., each row unit 12 of the agricultural implement 10) includes a tine rake assembly 20 configured to reduce plugging within a respective finishing assembly 22. As discussed in detail below, the finishing assembly 22 includes ground engaging tools configured to finish the soil surface. As illustrated, the finishing assembly 22 is positioned rearward of the other ground engaging tools of the row unit 12 with respect to a direction of travel 30. Furthermore, as discussed in detail below, the tine rake assembly 20 includes a frame configured to rotate between a working position and at least one storage position. The tine rake assembly 20 also includes tines non-movably coupled to the frame. Each tine is configured to be disposed within a region extending between a respective pair of ground engaging tools of the finishing assembly 22 while the frame is in the working position. Otherwise, each tine of the tine rake assembly 20 is configured to be disengaged from the region while the frame is in the at least one storage position. Accordingly, the difficulty associated with cleaning the tine rake assembly 20 may be substantially reduced (e.g., as compared to a tine rake assembly having a non-rotatable frame).

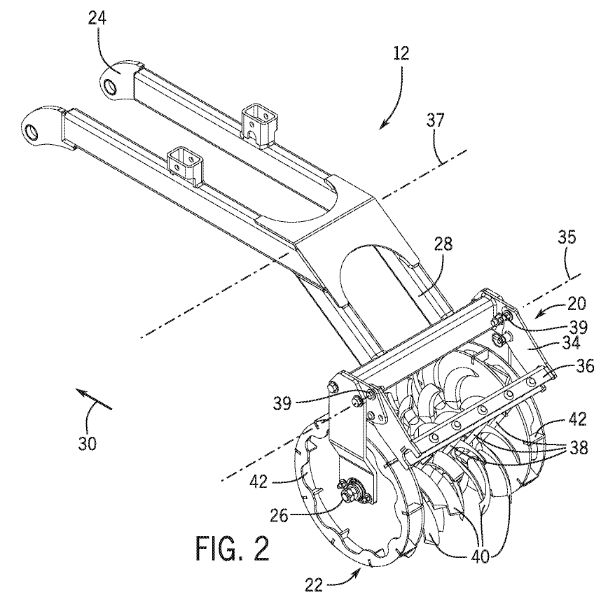

FIG. 2 is a perspective view of an embodiment of a row unit 12 that may be employed within the agricultural implement of FIG. 1. The row unit 12 includes the finishing assembly 22. As illustrated, the row unit 12 includes a mount 24 configured to pivotally couple the row unit 12 to the tool bar of the agricultural implement. The pivotal connection between the row unit 12 and the toolbar enables the row unit 12 to pivot relative to the tool bar in response to variations in the soil surface. While the row unit 12 is pivotally coupled to the toolbar in the illustrated embodiment, in other embodiments, the row unit may be non-pivotally coupled to the toolbar. The mount 24 is coupled to a chassis (e.g., row unit chassis) 28 of the row unit 12. The chassis 28 may be formed from any suitable components (e.g., bars, plates, etc.) coupled to one another via any suitable type(s) of connection(s) (e.g., welded connection(s), adhesive connection(s), fastener connection(s), etc.).

Each of the ground engaging tools disclosed above is coupled to the chassis 28 of the row unit 12. For example, disc blades configured to break up a top layer of the soil, a residue management wheel configured to break up and/or displace residue on the surface of the field, closing disc(s) configured to move displaced soil over the agricultural product, other suitable ground engaging tool(s), or a combination thereof, may be coupled to the chassis 28 of the row unit 12. In addition, other suitable component(s) (e.g., downforce spring(s), sensor(s), actuator(s)) may be coupled to the chassis 28. Additionally, in certain embodiments, the row unit 12 includes an agricultural product conveying system (e.g., agricultural product tube) configured to deposit agricultural product (e.g., fertilizer) into the soil or onto the soil. In such embodiments, the agricultural product conveying system may be coupled to the chassis 28 of the row unit 12.

Furthermore, the row unit 12 includes the finishing assembly 22 configured to condition the soil. The finishing assembly 22 includes multiple ground engaging tools. In the illustrated embodiment, the ground engaging tools include a set of spike wheels 40 distributed across a width of the finishing assembly 22. The ground engaging tools also include a pair of gauge wheels 42, and the distributed spike wheels 40 are located in between the pair of gauge wheels 42. The pair of gauge wheels 42 is configured to control a penetration depth of the spike wheels 40 into the soil. Furthermore, the spike wheels 40 and the gauge wheels 42 are rotatably coupled to the chassis 28 of the row unit 12 via a shaft 26. Accordingly, movement of the row unit 12 along the direction of travel 30 drives the spike wheels 40 and the gauge wheels 42 to rotate. While the ground engaging tools include the spike wheels and the gauge wheels in the illustrated embodiment, in other embodiments, the finishing assembly 22 may include other suitable ground engaging tool(s) (e.g., alone or in combination with the spiked wheels 40 and/or the gauge wheels 42), such as fluted disc(s), concave disc(s), coulter(s), etc.

In addition, the finishing assembly 22 includes the tine rake assembly 20. The tine rake assembly 20 includes a frame 34 pivotally coupled to the chassis 28 of the row unit 12, thereby enabling the frame 34 to pivot relative to the chassis 28 about a pivot axis 35 parallel to a lateral axis 37 of the row unit 12. In the illustrated embodiment, the frame 34 is pivotally coupled to the row unit chassis 28 via fasteners 39. However, in other embodiments, the frame may be pivotally coupled to the row unit chassis via pin(s), shaft(s), etc. The frame 34 includes a support 36 supporting multiple tines 38 distributed across a width of the support 36 (e.g., extent of the support 36 with respect to the lateral axis 37). The tines 38 are non-movably coupled to the support 36 of the frame 34. While the tine rake assembly 20 is coupled to the row unit chassis 28 in the illustrated embodiment, in other embodiments, the tine rake assembly may be coupled to the chassis of the agricultural implement.

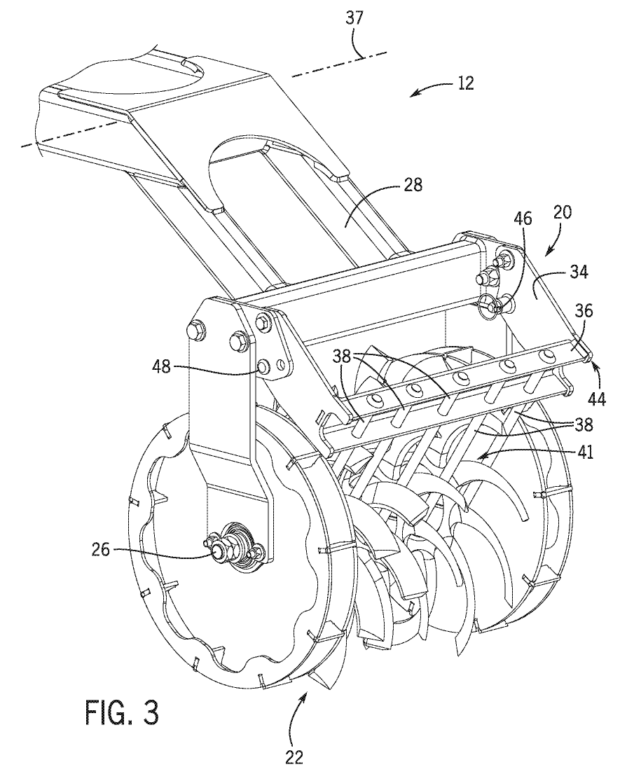

FIG. 3 is a perspective view of an embodiment of the tine rake assembly 20 that may be employed within the row unit 12 of FIG. 2, in which the frame 34 of the tine rake assembly 20 is in a working position 44. As previously discussed, the finishing assembly 22 includes multiple ground engaging tools, and the tine rake assembly 20 includes multiple tines 38. In the illustrated embodiment, the frame of the tine rake assembly 20 is pivotally coupled to the row unit chassis 28. The frame 34 of the tine rake assembly 20 may be rotated to the working position 44 (e.g., while the row unit is operating in certain soil conditions, such as wet soil conditions) to enable the tines 38 to reduce build-up of environmental elements (e.g., soil, residue, etc.) between the ground engaging tools of the finishing assembly 22.

Each tine 38 is disposed within a region 41 extending between a respective pair of ground engaging tools of the finishing assembly 22 while the frame 34 is in the illustrated working position. As used herein, “region extending between a respective pair of ground engaging tools” refers to a volume having a first end defined by one ground engaging tool, a second end defined by a directly adjacent ground engaging tool with respect to the lateral axis 37, and an extent defined by the spacing between the respective pair of ground engaging tools along the lateral axis 37. Because the tine is within the region 41, the tine 38 may reduce build-up of the environmental elements between the respective pair of ground engaging tools of the finishing assembly 22. In the illustrated embodiment, the tine rake assembly 20 includes five tines 38. However, in other embodiments, the tine rake assembly may include more or fewer tines (e.g., one tine for each region).

The tine rake assembly 20 includes a set of pins 46 positioned on opposing lateral sides of the frame 34 and configured to block rotation of the frame 34 and to support the frame 34 while the frame is in the illustrated working position 44. With the frame 34 in the illustrated working position 44, the pins 46 are secured within a first set of apertures 48 in the row unit chassis 28, thereby supporting the frame 34 in the working position. Each pin may be retained by any suitable type of retention system (e.g., cotter pin, clip, etc.). With the frame 34 in the working position 44, the tines 38 extend into the regions 41, as discussed above. In the illustrated embodiment, the tines extend generally inwardly toward the shaft 26 (e.g., plus or minus 45 degrees from a radial axis extending from the shaft).

In the illustrated embodiment, the tines 38 have a circular cross-sectional shape and are straight. In other embodiments, the tines 38 may have another suitable cross-sectional shape (e.g., ovular, rectangular, polygonal, star-shaped, etc.) and/or may be curved, angled, etc. In addition, in the illustrated embodiment, the tines 38 are non-removably coupled to the support 36 (e.g., via welded connections). However, in other embodiments, the tines may be non-movably coupled to the shaft 36 via removable connections (e.g., threaded, pinned, etc.).

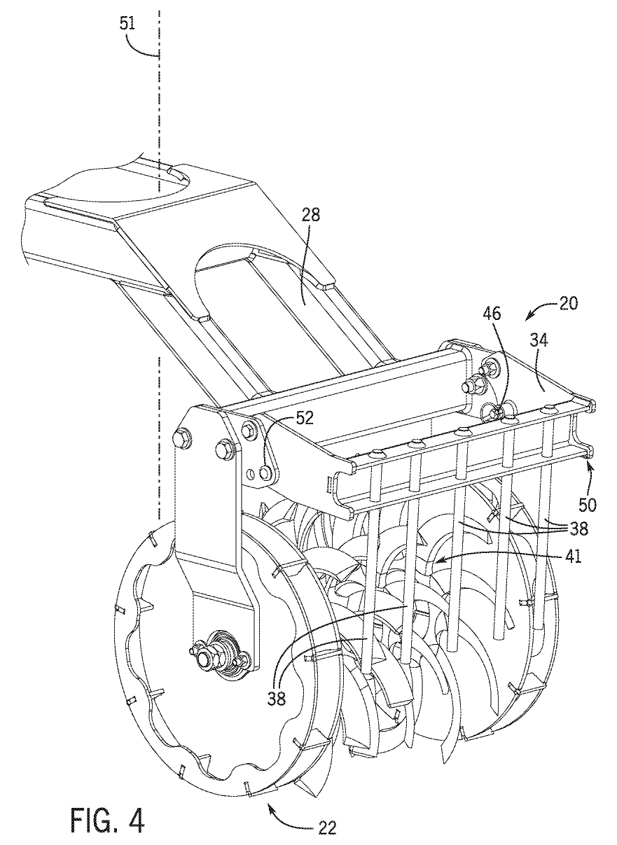

FIG. 4 is a perspective view of the tine rake assembly 20 of FIG. 3, in which the frame 34 of the tine rake assembly 20 is in a first storage position 50. As previously discussed, the finishing assembly 22 includes multiple ground engaging tools, and the tine rake assembly 20 includes multiple tines 38. In the illustrated embodiment, the tine rake assembly 20 is pivotally coupled to the row unit chassis 28. The frame 34 of the time rake assembly 20 may be rotated to the first storage position 50 (e.g., while the row unit is operating in certain soil conditions, such as dry soil conditions, while the row unit is disengaged from the soil for transport, etc.), such that the tines 38 disengage the respective regions 41.

The set of pins 46, which are positioned on opposing lateral sides of the frame 34, are configured to block rotation of the frame 34 and to support the frame 34 while the frame 34 is in the illustrated first storage position 50. While the frame 34 is in the first storage position 50, the pins 46 are secured within a second set of apertures 52 in the row unit chassis 28, thereby supporting the frame 34 in the first storage position 50. With the frame 34 in the first storage position 50, the tines 38 do not extend within the respective regions 41 between the ground engaging tools of the finishing assembly 22. Furthermore, in the illustrated embodiment, with the frame 34 in the first storage position 50, the tines extend generally downwardly toward the soil surface. As used herein with regard to the tines, extending “generally downwardly” refers to an angle between each tine 38 and a vertical axis 51 of the row unit 12 of less than 60 degrees, in which a distal end of each tine is positioned below an end of the tine coupled to the support.

To move the frame 34 from the working position, as shown in FIG. 3, to the illustrated first storage position 50, the pins 46 may be removed from the first set of apertures 48, the frame 34 may be rotated to the first storage position 50, and the pins 46 may be disposed within the second set of apertures 52. In addition, to move the frame 34 from the illustrated first storage position 50 to the working position, as shown in FIG. 3, the pins 46 may be removed from the second set of apertures 52, the frame 34 may be rotated to the working position, and the pins 46 may be disposed within the first set of apertures 48. While the frame is secured in the working position and the first storage position with a pin/aperture assembly in the illustrated embodiment, in other embodiments, the frame may be secured in the working position and the first storage position via another suitable locking assembly, such as an arm coupled to the tine rake assembly frame and configured to selectively engage one of multiple notches on the row unit chassis, pin(s) engaged with slot(s) (e.g., in the tine rake assembly frame, in the row unit chassis), etc.

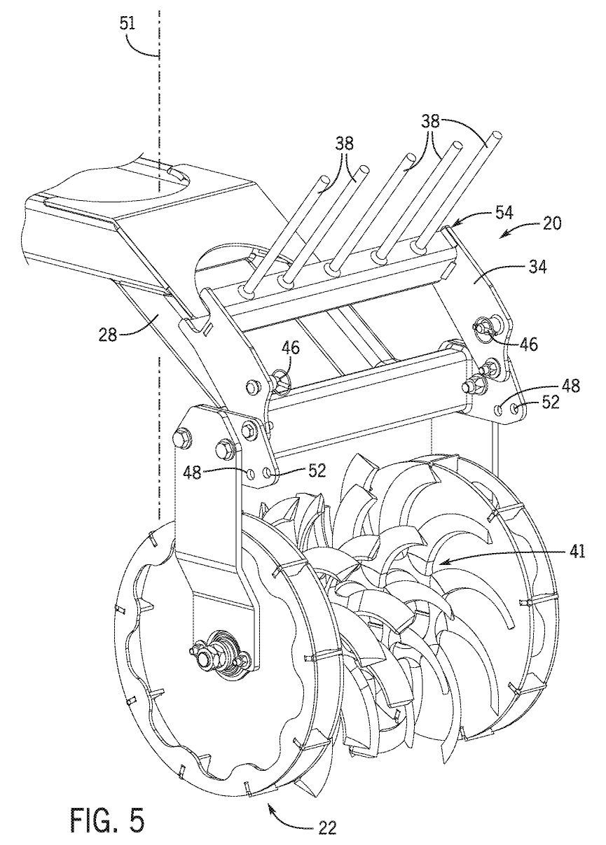

FIG. 5 is a perspective view of the tine rake assembly 20 of FIG. 3, in which the frame of the tine rake assembly 20 is in a second storage position 54. As previously discussed, the finishing assembly 22 includes multiple ground engaging tools, and the tine rake assembly 20 includes multiple tines 38. In the illustrated embodiment, the tine rake assembly 20 is pivotally coupled to the row unit chassis 28. The frame 34 of the tine rake assembly 20 may be rotated to the second storage position 54 (e.g., while the implement is not moving) to enhance access to the tines 38 (e.g., for cleaning, etc.) and to enhance access to the regions 41 between the ground engaging tools (e.g., for cleaning, etc.).

With the frame 34 in the illustrated second storage position 54, the pins 46 are not engaged with either the first set of apertures 48 or the second set of apertures 52. Instead, the frame rests on the row unit chassis 28 in an “over center” position, such that gravity holds the frame 34 in the illustrated second storage position 54. With the frame 34 in the second storage position 54, the tines 38 do not extend within the regions 41 between the ground engaging tools. In the illustrated embodiment, with the frame 34 in the second storage position 54, the tines extend generally upwardly away from the soil surface. As used herein with regard to the tines, extending “generally upwardly” refers to an angle between each tine 38 and the vertical axis 51 of the row unit 12 of less than 60 degrees, in which the distal end of each tine is positioned above the end of the tine coupled to the support.

While the frame 34 is not secured in the second storage position with the pins in the illustrated embodiment, in other embodiments, the row unit chassis may include a third set of apertures, and the pins may be disposed within the third set of apertures while the frame is in the second storage position. Furthermore, while the tine rake assembly includes two storage positions in the illustrated embodiment, in other embodiments, the tine rake assembly may include more or fewer storage positions (e.g., 1, 3, 4, or more). In addition, while the tine rake assembly is pivotally coupled to the chassis of the row unit in the illustrated embodiment, in other embodiments (e.g., in embodiments in which the tillage implement does not include row units, and ground engaging tools are coupled directly to a main chassis of the tillage implement), the tine rake assembly may be pivotally coupled to the chassis (e.g., main chassis) of the agricultural implement. Accordingly, as used herein with regard to the pivotal coupling between the frame of the tine rake assembly and the chassis, “chassis” refers to any chassis of the agricultural implement, such as a main chassis, a chassis of a sub-frame, the chassis of the row unit, etc.

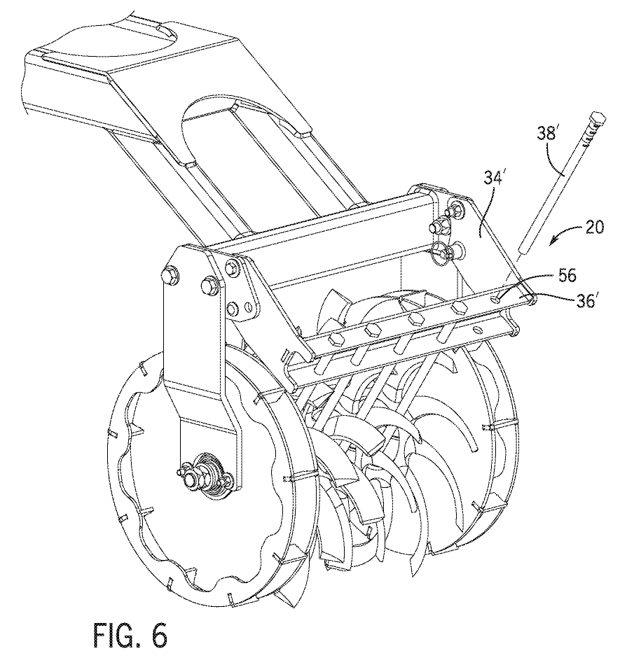

FIG. 6 is a perspective view of the tine rake assembly 20 of FIG. 3, in which one tine 38’ is separated from the frame 34’. In the illustrated embodiment, each tine 38’ is removably and non-movably coupled to the support 36’ via a respective threaded connection 56. Accordingly, each tine may be removed and replaced via rotation of the tine relative to the support. Furthermore, in certain embodiments, each tine may be removably and non-movably coupled to the support via any other suitable type of removable connection (e.g., pinned, etc.). In addition, as discussed above with regard to the embodiment of FIGS. 3-5, the tines may be non-removably coupled to the support (e.g., via welded connections).

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] …” or “step for [perform]ing [a function]…”, it is intended that such elements are to be interpreted under 35 U.S.C. 112(f). However, for any claims containing elements designated in any other manner, it is intended that such elements are not to be interpreted under 35 U.S.C. 112(f).

1. A tine rake assembly for an agricultural implement, comprising:
a frame configured to pivotally couple to a chassis of the agricultural implement, wherein the frame is configured to rotate between a working position and at least one storage position; and
a plurality of tines non-movably coupled to the frame, wherein each tine of the plurality of tines is configured to be disposed within a region extending between a respective pair of ground engaging tools while the frame is in the working position, and each tine of the plurality of tines is configured to be disengaged from the region while the frame is in the at least one storage position.

2. The tine rake assembly of claim 1, wherein the at least one storage position comprises a first storage position, wherein each tine of the plurality of tines extends generally downwardly toward a soil surface while the frame is in the first storage position.

3. The tine rake assembly of claim 2, comprising a plurality of pins, wherein each pin of the plurality of pins is configured to support the frame in the working position and in the first storage position.

4. The tine rake assembly of claim 2, wherein the at least one storage position comprises a second storage position, and each tine of the plurality of tines extends generally upwardly away from the soil surface while the frame is in the second storage position.

5. The tine rake assembly of claim 1, comprising a plurality of pins, wherein each pin of the plurality of pins is configured to support the frame in the working position.

6. The tine rake assembly of claim 1, wherein each tine of the plurality of tines is attached to the frame with a removable connection.

7. The tine rake assembly of claim 1, wherein each tine of the plurality of tines has a circular cross-sectional shape.

8. A row unit for an agricultural implement, comprising:
a chassis;
a plurality of ground engaging tools coupled to the chassis; and
a tine rake assembly, comprising:
a frame pivotally coupled to the chassis, wherein the frame is configured to rotate between a working position and at least one storage position; and
a plurality of tines non-movably coupled to the frame, wherein each tine of the plurality of tines is configured to be disposed within a region extending between a respective pair of ground engaging tools of the plurality of ground engaging tools while the frame is in the working position, and each tine of the plurality of tines is configured to be disengaged from the region while the frame is in the at least one storage position.

9. The row unit of claim 8, wherein the at least one storage position comprises a first storage position, wherein each tine of the plurality of tines extends generally downwardly toward a soil surface while the frame is in the first storage position.

10. The row unit of claim 9, comprising a plurality of pins, wherein each pin of the plurality of pins is configured to support the frame in the working position and in the first storage position.

11. The row unit of claim 9, wherein the at least one storage position comprises a second storage position, and each tine of the plurality of tines extends generally upwardly away from the soil surface while the frame is in the second storage position.

12. The row unit of claim 8, comprising a plurality of pins, wherein each pin of the plurality of pins is configured to support the frame in the working position.

13. The row unit of claim 8, wherein each tine of the plurality of tines is attached to the frame with a removable connection.

14. The row unit of claim 8, wherein each tine of the plurality of tines has a circular cross-sectional shape.

15. An agricultural implement, comprising:
a chassis;
a plurality of ground engaging tools coupled to the chassis; and
a tine rake assembly, comprising:
a frame configured to pivotally couple to the chassis, wherein the frame is configured to rotate between a working position and at least one storage position; and
a plurality of tines non-movably coupled to the frame, wherein each tine of the plurality of tines is configured to be disposed within a region extending between a respective pair of ground engaging tools of the plurality of ground engaging tools while the frame is in the working position, and each tine of the plurality of tines is configured to be disengaged from the region while the frame is in the at least one storage position.

16. The agricultural implement of claim 15, wherein the at least one storage position comprises a first storage position, wherein each tine of the plurality of tines extends generally downwardly toward a soil surface while the frame is in the first storage position.

17. The agricultural implement of claim 16, comprising a plurality of pins, wherein each pin of the plurality of pins is configured to support the frame in the working position and in the first storage position.

18. The agricultural implement of claim 16, wherein the at least one storage position comprises a second storage position, and each tine of the plurality of tines extends generally upwardly away from the soil surface while the frame is in the second storage position.

19. The agricultural implement of claim 15, comprising a plurality of pins, wherein each pin of the plurality of pins is configured to support the frame in the working position.

20. The agricultural implement of claim 15, wherein each tine of the plurality of tines is attached to the frame with a removable connection.
